(19) United States
(12) Patent Application Publication
(10) Pub. No.: US 2024/0273802 A1
(43) Pub. Date: Aug. 15, 2024

(54) FREQUENCY AND OCCLUSION REGULARIZATION FOR NEURAL RENDERING SYSTEMS AND APPLICATIONS

(71) Applicant: NVIDIA Corporation, Santa Clara, CA (US)

(72) Inventors: Yue Wang, Mountain View, CA (US); Marco Pavone, Stanford, CA (US); Jiawei Yang, Los Angeles, CA (US)

(21) Appl. No.: 18/422,650

(22) Filed: Jan. 25, 2024

Related U.S. Application Data
(60) Provisional application No. 63/484,059, filed on Feb. 9, 2023.

(51) Int. Cl. G06T 15/00; G06T 15/06

(52) U.S. Cl. CPC G06T 15/005; G06T 15/06

(57) ABSTRACT

In various examples, frequency regularization and/or occlusion regularization techniques may be used to train Neural Radiance Fields (NeRF) to determine neural renderings based at least on sparse inputs in a way that reduces overfitting, underfitting, and/or occlusions. For example, while training a NeRF, a linearly increased frequency mask may be applied to regularize a visible frequency spectrum of training data based on training time steps. In examples, as training of the NeRF progresses, the visible frequency may be increased in a way that reduces the risk of overfitting and/or avoids underfitting. Additionally, the disclosed techniques may also include masking one or more density scores located within a threshold proximity of an origin of a ray to reduce floaters, walls, and other occlusions in the neural rendering output.

### CROSS-REFERENCE TO RELATED APPLICATIONS

This application claims the benefit of U.S. Provisional Application No. 63/484,059, filed on Feb. 9, 2023, which is incorporated herein by reference in its entirety and for all purposes.

### BACKGROUND

Novel view synthesis is a critical aspect in computer vision, computer graphics, and augmented reality, allowing for the creation of realistic and immersive visual experiences. Among several other applications, virtual reality, gaming, content creation, and simulation have particularly benefited in recent years from surges in the development of novel view synthesis techniques, especially with the emergence of Neural Radiance Fields (NeRF). However, novel view synthesis with sparse inputs, also referred to as “few-shot neural rendering,” remains a challenging problem for NeRF. Despite recent progress, NeRF still requires hundreds and/or even thousands of input images to learn and/or produce high-quality scene representations. That is, NeRF fails to synthesize novel views with minimal input views (e.g., 3, 6, 9, etc.), thereby hindering NeRF-based applications in real-world scenarios. These problems still exist even with the recent introduction of external supervision, non-trivial patch-based rendering, and other NeRF variants.

Many have attempted to address few-shot neural rendering problems by leveraging a external model(s) to acquire normalization-flow-based regularization, perceptual regularization, depth supervision, and/or cross-view semantic consistency. Additionally, instead of using external model(s), others have attempted to learn transferable models by training on a large, curated dataset. Still different from these techniques, recent works argue that geometry is the most important factor in few-shot neural rendering, and some have proposed geometry regularization for better performance. However, these techniques require expensive pre-training on tailored, multi-view datasets and/or costly training-time patch rendering, thus introducing significant overhead in methodology, engineering implementation, and training budgets.

### SUMMARY

Embodiments of the present disclosure relate generally to frequency and occlusion regularization for neural rendering systems and applications. Systems and methods are disclosed that use frequency regularization and/or occlusion regularization to train a Neural Radiance Field (NeRF) to generate and/or determine, based on sparse input data (e.g., few-shot), a neural rendering (e.g., 3D scene) that minimizes and/or reduces overfitting, underfitting, and occlusions. For example, a positional encoding of a dataset may be obtained for training the NeRF, and a linearly increased frequency mask may be used to regularize a visible frequency spectrum in the positional encoding based at least on training time steps. In this way, as training of the NeRF progresses, the visible frequency of the positional encoding used to train the NeRF increases. Additionally, in some examples, the systems and methods may include masking one or more density scores located within a threshold proximity of an origin of a ray to reduce floaters, walls, and other occlusions in the neural rendering output.

In contrast to conventional systems, the present systems and methods, in embodiments, are able to increase performance of few-shot neural rendering and novel view synthesis with minimal modifications to traditional NeRF systems, while maintaining computational efficiency and without increasing computational costs. For instance, and as described in more detail herein, by gradually increasing the visibility of high-frequency signals in training data (e.g., positional encodings), the frequency regularization techniques described herein help NeRF models reduce the risk of overfitting, which can cause catastrophic failure at the beginning of training, and avoids underfitting, which can cause over-smoothness at the end of training. Additionally, by reducing the influence (e.g., masking, penalizing, excluding, etc.) of dense fields near the camera or other origin, the occlusion regularization techniques disclosed herein help improve the accuracy and realism of NeRF 3D scene representations by reducing floaters, walls, and other occlusions.

### BRIEF DESCRIPTION OF THE DRAWINGS

The present systems and methods for frequency and occlusion regularization for neural rendering systems and applications are described in detail below with reference to the attached drawing figures, wherein:

FIG. 1 is a data flow diagram illustrating an example process associated with training a NeRF to generate a few-shot neural rendering, in accordance with some embodiments of the present disclosure;

FIG. 2 is a data flow diagram illustrating an example process associated with using frequency regularized inputs to train a NeRF, in accordance with some embodiments of the present disclosure;

FIG. 3 is a graph illustrating a linear relationship between frequency mask values and training iterations for frequency regularized training of a NeRF, in accordance with some embodiments of the present disclosure;

FIG. 4 is a data flow diagram illustrating an example process associated with training a NeRF that utilizes occlusion regularization, in accordance with some embodiments of the present disclosure;

FIG. 5 is a data flow diagram illustrating an example process associated with a NeRF that utilizes occlusion regularization techniques to generate few-shot neural renderings, in accordance with some embodiments of the present disclosure;

FIG. 6 is a block diagram illustrating example details of a neural rendering system, in accordance with some embodiments of the present disclosure;

FIG. 7 is a flowchart illustrating an example method associated with training a NeRF to generate a few-shot neural rendering, in accordance with some embodiments of the present disclosure;

FIG. 8 is a flowchart illustrating an example method associated with using frequency regularization when training a NeRF to generate a few-shot neural rendering, in accordance with some embodiments of the present disclosure;

FIG. 9 is a flowchart illustrating an example method associated with using occlusion regularization in association with a NeRF to generate a few-shot neural rendering, in accordance with some embodiments of the present disclosure;

FIG. 10 is a block diagram illustrating an example computing device suitable for use in implementing some embodiments of the present disclosure; and

FIG. 11 is a block diagram illustrating an example data center suitable for use in implementing some embodiments of the present disclosure.

### DETAILED DESCRIPTION

Systems and methods are disclosed related to frequency and occlusion regularization for neural rendering systems and applications. For instance, a system(s) may implement frequency regularization and/or occlusion regularization techniques, as disclosed herein, to generate a few-shot neural rendering using a Neural Radiance Field (NeRF). In some examples, frequency regularization may directly regularize a visible frequency band(s) of NeRF inputs to stabilize the learning process. In some examples, frequency regularization may help avoid various failure modes including, but not limited to, overfitting, which generally occurs at the start of training, and underfitting, which can lead to over-smoothness at the end of training. In contrast to frequency regularization, occlusion regularization, in some examples, penalizes near-origin (e.g., near-camera) density fields that can lead to occlusions (e.g., “floaters,” “walls,” etc.) in a neural rendering. The techniques disclosed herein for a NeRF system(s) that utilize frequency regularization and occlusion regularization may also be referred to herein, and known in the art, as “Frequency Regularized NeRF,” which may be abbreviated as, simply, “FreeNeRF.”

In some examples, and in accordance with the techniques disclosed herein, the system(s) may receive and/or obtain a dataset for training a neural radiance field (NeRF) to generate a few-shot neural rendering that includes a three-dimensional (3D) scene. In some examples, the dataset may be used to train the NeRF to understand 3D structure of scene(s), allowing the NeRF to generate novel views or render scene(s) from different perspectives. In some examples, the dataset may include one or more images and/or scenes captured from various viewpoints, along with corresponding depth and color information. That is, the dataset may include various images, depth maps, camera poses, and other/or information needed to train and test the NeRF model effectively.

In some examples, to train the NeRF in accordance with the techniques disclosed herein, one or more positional encodings may be utilized as training data/inputs for optimizing the NeRF. In some examples, the positional encoding(s) may be included in the dataset and/or may be generated by the system(s) based on the information included in the dataset. In this way, instead of training/optimizing the NeRF over raw inputs, which can lead to difficulty in synthesizing high frequency details, the raw inputs can be mapped into a higher dimensional space in a positional encoding using, for example, sinusoidal functions with different frequencies.

In accordance with the frequency regularization techniques disclosed herein, in some examples, the system(s) may train/optimize the NeRF using a masked (e.g., integrated) version of the positional encoding(s) from the training dataset. In some examples, this may be achieved by adding a line of code to implement frequency regularization, such as, for instance:

$${pos}_{enc [ i n t ( \frac{t * L}{T} ) + 3 : ]} = 0$$

where t denotes the current training iteration, T denotes the regularization duration, and L is the dimension of the input positional encoding. As an example of the occlusion regularization process for training/optimizing a NeRF, given a positional encoding of length L+3, a linearly increased frequency mask α may be used to regularize the visible frequency spectrum based on training time steps, formally as:

$${{γ}^{′}}_{L} ( t , T ; x ) = γ L ( x ) ⊙ α ( t , T , L ) ,$$

$$with$$

$${α}_{i} ( t , T , L ) = \{ \begin{matrix}1 & if & i \leq \frac{t * L}{T} + 3 \\ \frac{t * L}{T} - ⌊ \frac{t * L}{T} ⌋ & if & \frac{t * L}{T} + 3 < i \leq \frac{t * L}{T} + 6 \\ 0 & if & i > \frac{t * L}{T} + 6\end{matrix}$$

where αᵢ(t, T, L) denotes the value of i-th bit of α(t, T, L), t represents the current training iteration, and T represents the end iteration of frequency regularization. In other words, to train/optimize the NeRF, the system(s) may start with raw inputs and linearly increase the visible frequency (e.g., by 3-bits in the above example equations) each time as training progresses.

Accordingly, in some examples, the system(s) may train/optimize the NeRF using frequency regularized inputs by inputting, to the NeRF during a first training iteration, a first positional encoding of the dataset. In some examples, the first positional encoding may be associated with a first length of a visible frequency band based at least on applying a first frequency mask to the first positional encoding. In other words, based at least on applying the first frequency mask, a first range of signals (e.g., low frequency signals) in the positional encoding/training data may be visible to the NeRF. After the first training iteration, in some examples, the system(s) may continue frequency regularized training by inputting, to the NeRF during a second training iteration, a second positional encoding of the dataset. In some examples, the second positional encoding may be associated with a second length of the visible frequency band based at least on applying a second frequency mask to the second positional encoding. That is, based at least on applying the second frequency mask, a second range of signals (e.g., low frequency signals and at least a portion of higher frequency signals) in the positional encoding/training data may be visible to the NeRF in the second iteration. In some examples, the system(s) may continue this training of the NeRF and progressively input higher frequency signals to the NeRF until training/optimization is complete.

In some examples, the first length of the visible frequency band may be shorter or otherwise associated with a lower frequency than the second length of the visible frequency band. That is, the first length may be shorter than the second length such that, in the second training iteration, the second positional encoding includes all the frequency signals from the first positional encoding in addition to new frequency signals that are higher in frequency than those from the first position encoding. In some examples, based at least on a difference between the first length of the visible frequency band and the second length of the visible frequency band, the first positional encoding may include a first signal of the dataset while excluding a second signal of the dataset. Additionally, the second positional encoding may include the first signal and the second signal while excluding a third signal of the data set. For instance, the third signal may have a frequency value that is outside of the first length and/or the second length of the visible frequency band.

Additionally, or alternatively, in some examples, the first length of the visible frequency band may be associated with a different section of the visible frequency band than the second length. That is, the first length may be associated with a first section or wavelength of the visible frequency band (e.g., 400-420 nm) while the second length may be associated with a second section or wavelength of the visible frequency band (e.g., 420-490 nm). In such examples, the second positional encoding used during the second training iteration may include different frequency signals associated with a higher frequency than the frequency signals included in the first positional encoding used during the first training iteration.

As noted above, in some examples a linear relationship may exist between a first value associated with the first frequency mask and a second value associated with the second frequency mask, as the mask value may increase linearly with each training iteration. However, the frequency regularization techniques disclosed herein are not limited to linearly increasing the visible frequency spectrum, and other relationships can be used to increase the visible frequency (e.g., exponential relationships, polynomial relationships, logarithmic relationships, step relationships, etc.).

As noted above, in some examples, the system(s) may continue this training of the NeRF and progressively input higher frequency signals to the NeRF until training/optimization is complete. In some examples, the NeRF may be optimized upon completion of each successive training iteration. That is, in some examples, after inputting the first positional encoding, losses may be computed and the NeRF model optimized before proceeding to the second training iteration. In some example, during each new iteration of training, the frequency mask may be increased, thereby increasing the length of the visible frequency band in the positional encoding. In other words, as training iterations progress, higher frequency signals in the training data will become visible to the NeRF. In some examples, this iterative training may continue until the full frequency range is visible to the NeRF and/or a computed loss is minimized or otherwise reduced below a threshold. As such, the system(s) may input, to the NeRF during a third training iteration that is subsequent to both the first training iteration and the second training iteration, a third positional encoding of the dataset. In some examples, such as if the third training iteration is the final iteration of training, the third positional encoding may be associated with a full length of the visible frequency band (e.g., all signals visible to the NeRF).

In some examples, the system(s) may additionally, or alternatively, utilize occlusion regularization to train/optimize the NeRF model. However, as previously noted, the use of occlusion regularization is not specifically limited to training/optimization cases, and may be utilized during any inference scenario as well. In some examples, when the system(s) implements occlusion regularization, the system(s) may penalize dense fields near a ray's origin (e.g., camera). In some examples, occlusion regularization losses may be defined as:

$${ℒ}_{occ} = \frac{{σ}_{K}^{T} \cdot {m}_{K}}{K} = \frac{1}{K} {Σ}_{K} {σ}_{K} \cdot {m}_{K} ,$$

$$with$$

$${m}_{K} ∈ \{ 0 , 1 \} ,$$

where m_{K} is a mask (e.g., binary mask) to indicate penalized bits, and ox denotes the density scores of the sampled K points along the ray from near to far with respect to the origin. In some examples, the lower M bits of m_{K} may be set to “1” and the upper Mbits of m_{K} may be set to “0” to reduce the near-origin dense fields and minimize occlusions.

In some examples, during training iterations (e.g., any one or more of the first training iteration, the second training iteration, the third training iteration, etc.), the system(s) may implement the occlusion regularization techniques disclosed herein, which may include causing a masking of one or more density scores located within a threshold proximity of an origin of a ray to reduce an occlusion in the neural rendering. However, as noted above, the occlusion regularization techniques disclosed herein are not limited to the context of training models, and may be utilized in inference scenarios as well when the NeRF (e.g., trained NeRF) is generating a novel view.

In the context of a neural rendering that includes a 3D scene, the training dataset may include an image (e.g., 2D image) of the scene that is to be recreated. In some examples, and in accordance with the occlusion regularization techniques disclosed herein, the system(s) may determine, using the NeRF, a first density score associated with a first point of multiple points disposed along a ray cast from an origin through a pixel of the image. In some examples, the first density score may be one of multiple density scores associated with respective points of the multiple points disposed along the ray. For instance, the first density score may be distinguishable from a second density score associated with a second point of the multiple points disposed along the ray. Additionally, in some examples, the ray may be one of multiple rays cast from the origin, and one or more rays (e.g., each ray) of the multiple rays may pass through a respective pixel of the image.

In some examples, a value of the first density score may correspond with the density at the point along the ray. That is, based at least on the value of the density score (e.g., 0.1, 0.5, 0.9, etc.), the density score may be indicative of whether the point along the ray intersects a dense region or a sparse region. In some examples, the first density score may be indicative of a presence of a “false dense region” (e.g., a dense region the NeRF detects/interprets, but which does not actually exist). In some examples, the false dense region may contribute to an occlusion in a novel 3D scene generated by the NeRF.

To minimize these occlusions, the system(s) may, in some examples, cause the first density score to be minimized and/or excluded when the NeRF determines the neural rendering. This may have the effect of reducing the occlusion in the neural rendering. In some examples, the system(s) may cause the first density score to be minimized and/or excluded based at least on a distance between the origin and the first point. For instance, if the distance between the origin and the first point is less than a threshold (e.g., 1 cm, 2 cm, etc.), then the system(s) may cause the first point/first density score to be minimized/excluded via the binary mask. In some examples, the system(s) may apply the binary mask across the entire data structure to minimize and/or exclude all points/density scores that are within the threshold distance of the origin. Additionally, or alternatively, the system(s) may identify a location(s) associated with the dense regions (e.g., from preliminary outputs, from non-overlapping regions in the input data/images, etc.) and apply the binary mask to at that/those location(s).

As noted above, the binary mask may be applied to mask density scores/points to a certain depth/distance away from the origin. In effect, the binary mask may allow the system(s) to cause a second density score to be included (e.g., considered by the NeRF in generating the neural rendering) based at least on a distance between the origin and the second point meeting or exceeding the threshold. That is, if the system(s) utilize the binary mask to exclude all points/density scores within a threshold distance (e.g., 1 cm, 2 cm, etc.) of the origin, then the points/density scores beyond that threshold distance may be left unmasked so that they are considered by the NeRF in rendering the novel view.

In examples, based at least on the various techniques disclosed above and/or herein, the system(s) may obtain a trained NeRF that is configured to generate few-shot neural rendering(s) while minimizing overfitting, underfitting, occlusions, and/or other failure modes in its output (e.g., neural rendering, 3D scene, novel view, etc.). That is, because the system(s) train/optimize the NeRF using the frequency regularized training data, the NeRF will inherently avoid overfitting and/or underfitting. Additionally, because the system(s) modify the NeRF to account for dense regions near a ray's origin, the system(s) can minimize the likelihood of a NeRF output including one or more occlusions.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

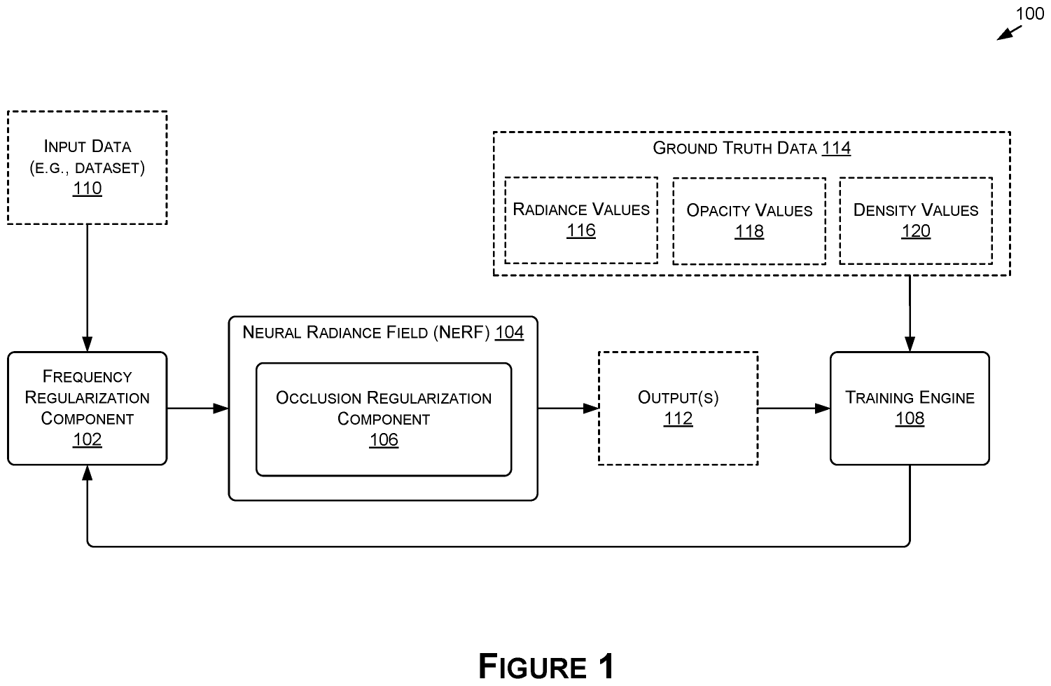

With reference to FIG. 1, FIG. 1 is a data flow diagram illustrating an example process 100 associated with training a NeRF to generate a few-shot neural rendering, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As illustrated in FIG. 1, various system(s) and component(s) may be involved in the process 100. For instance, a frequency regularization component 102, a Neural Radiance Field (NeRF) 104, an occlusion regularization component 106, and a training engine 108 may perform various operations associated with the process 100.

In some examples, the process 100 may begin by the frequency regularization component 102 receiving and/or obtaining input data 110. In some examples, the input data 110 may be a dataset for training the NeRF 104 to generate a few-shot neural rendering. In some examples, the dataset may be used to train the NeRF to understand 3D structure of scene(s), allowing the NeRF to generate novel views or render scene(s) from different perspectives. In some examples, the dataset may include one or more images or scenes captured from various viewpoints, along with corresponding depth and color information. That is, the dataset may include various images, depth maps, camera poses, and other/or information needed to train and test the NeRF model effectively.

In some examples, the input data 110 may include one or more positional encoding(s) for optimizing the NeRF. Additionally, or alternatively, the frequency regularization component 102 (or another component or system) may be configured to determine one or more positional encodings based on the input data 110. In this way, instead of training/optimizing the NeRF 104 over raw inputs, which can lead to difficulty in synthesizing high frequency details, the raw inputs can be mapped into a higher dimensional space in a positional encoding using, for example, sinusoidal functions with different frequencies.

In examples, the frequency regularization component 102 may determine, using a frequency mask, frequency regularized inputs based on the positional encoding for training the NeRF 104. In examples, the frequency regularization component 102 may start with raw inputs and increase the visible frequency of the training inputs during one or more iterations (e.g., during each iteration) as training progresses. For instance, in FIG. 1, after the process flows from the training engine 108 back to the frequency regularization component 102, the frequency regularization component 102 may increase the visible frequency.

The frequency regularization component 102 may, after regularizing the frequency of the positional encoding, provide the frequency regularized positional encoding to the NeRF 104 for a first iteration of training/optimization. In some examples, during this first training iteration, the positional encoding may be associated with a first length of a visible frequency band. In other words, based at least on applying the first frequency mask, a first range of signals (e.g., low frequency signals) in the positional encoding/training data may be visible to the NeRF 104.

In some examples, the NeRF 104 may perform ray casting to render a 3D scene. As part of this, the NeRF 104 may determine a first density score associated with a first point of multiple points disposed along a ray cast from an origin through a pixel of an input image. In some examples, the first density score may be one of multiple density scores associated with respective points of the multiple points disposed along the ray. For instance, the first density score may be distinguishable from a second density score associated with a second point of the multiple points disposed along the ray. Additionally, in some examples, the ray may be one of multiple rays cast from the origin, and one or more rays (e.g., each ray) of the multiple rays may pass through a respective pixel of the image.

In examples, the occlusion regularization component 106 may perform occlusion regularization on the density scores determined by the NeRF during ray casting. For instance, the occlusion regularization component 106 may penalize dense fields near a ray's origin (e.g., camera) so that the NeRF 104 does not misinterpret those dense fields and include occlusion(s) in the output(s) 112. For instance, the occlusion regularization component 106 may mask one or more density scores/points that are located within a threshold proximity of an origin of a ray to reduce an occlusion in the output(s) 112. That is, the occlusion regularization component 106 may cause one or more density scores to be excluded when the NeRF 104 determines the neural rendering output(s) 112. This may have the effect of reducing occlusions in the output(s) 112. In some examples, the occlusion regularization component 106 may cause density score(s) to be excluded based at least on a distance between the origin and point(s) corresponding with the density score(s). For instance, if the distance between the origin and a point is less than a threshold (e.g., 1 cm, 2 cm, etc.), then the occlusion regularization component 106 may cause that point and/or its density score to be excluded via the binary mask.

After processing the input training data, the NeRF 104 may generate an output(s) 112. In examples, the output(s) 112 may include a neural rendering based on the input training data. The training engine 108 may compare the output(s) 112 with ground truth data 114 to compute losses and optimize the NeRF 104. The ground truth data 114 may include, but is not limited to, radiance values 116, opacity values 118, and/or density values 120. These values may be compared with respective counterpart values in the output(s) 112 to evaluate the performance of the NeRF 104. For instance, losses may be calculated based on differences in the ground truth data values and the output values to determine metrics, and the training engine 108 may optimize the NeRF 104 based on these losses and/or metrics.

In some examples, the radiance values 116 may be a measure of intensity of light emitted or reflected from a point in a 3D scene. The radiance values 116 may indicate how much light is emitted or reflected from a point in a ground truth scene. In some examples, the opacity values 118 may represent the transparency or translucency of a point in a 3D scene. That is, the opacity values 118 may indicate how much light can pass through a particular point in a ground truth scene. The density values 120 are indicative of volumetric information within a scene. The density values may indicate how much matter or content is present at different points in space of a ground truth scene.

The training engine 108 may compare the radiance, opacity, and density values of a point in 3D space that is included in the output(s), with respective radiance, opacity, and density values of a point included in the ground truth data 114 to determine losses and optimize the NeRF 104. After the training engine 108 optimizes the NeRF 104 after one training iteration, the process 100 repeats with the frequency regularization component 102 using an increased frequency mask to train the NeRF 104 with a higher level of frequency signals. This repetitive training process may continue to repeat until the NeRF 104 is trained with full-frequency signals and/or the output(s) 112 of the NeRF are satisfactory (e.g., losses are minimized).

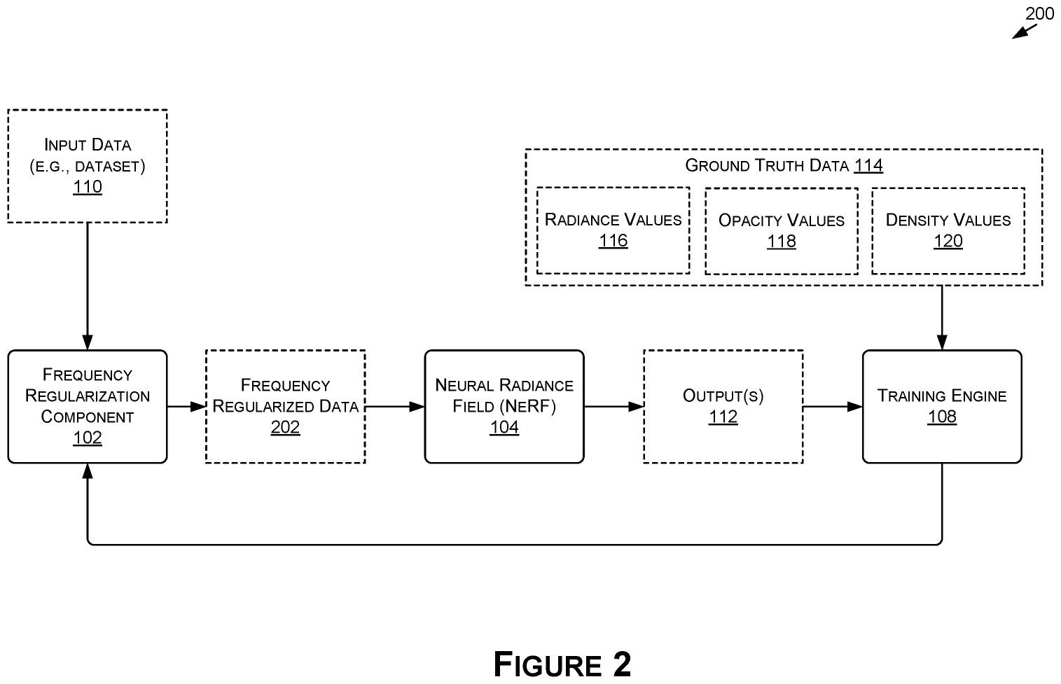

FIG. 2 is a data flow diagram illustrating an example process 200 associated with using frequency regularized inputs to train a NeRF 104, in accordance with some embodiments of the present disclosure. As illustrated in FIG. 2, various system(s) and component(s) may be involved in the process 200. For instance, the frequency regularization component 102, the NeRF 104, and the training engine 108 may perform various operations associated with the process 200.

In some examples, the process 200 may begin by the frequency regularization component 102 receiving or otherwise obtaining input data 110. In some examples, the input data 110 may be a dataset for training the NeRF 104 to generate a few-shot neural rendering. In some examples, the dataset may be used to train the NeRF to understand 3D structure of scene(s), allowing the NeRF to generate novel views or render scene(s) from different perspectives. In some examples, the dataset may include one or more images or scenes captured from various viewpoints, along with corresponding depth and color information. That is, the dataset may include various images, depth maps, camera poses, and other/or information needed to train and test the NeRF model effectively.

In some examples, the input data 110 may include a positional encoding(s) for optimizing the NeRF 104. Additionally, or alternatively, the frequency regularization component 102 (or another component or system) may be configured to determine the positional encoding(s) based at least on the input data 110. In this way, instead of training/optimizing the NeRF 104 over raw inputs, which can lead to difficulty in synthesizing high frequency details, the raw inputs can be mapped into a higher dimensional space in a positional encoding using, for example, sinusoidal functions with different frequencies.

In some examples, the frequency regularization component 102 may determine, using a frequency mask, frequency regularized data 202 based on the positional encoding for training the NeRF 104. In some examples, the frequency regularization component 102 may start with raw inputs and increase the visible frequency of the frequency regularized data 202 during one or more iterations (e.g., each iteration) as training progresses. For instance, in FIG. 2, after the process flows from the training engine 108 back to the frequency regularization component 102, the frequency regularization component 102 may increase the visible frequency in the frequency regularized data 202.

The frequency regularization component 102 may, after regularizing the frequency of the positional encoding, provide the frequency regularized data 202 to the NeRF 104 for a first iteration of training/optimization. In examples, during this first training iteration, the frequency regularized data 202 (e.g., positional encoding) may be associated with a first length of a visible frequency band. In other words, based at least on applying the first frequency mask, a first range of signals (e.g., low frequency signals) in the frequency regularized data 202 may be visible to the NeRF 104.

The NeRF may receive the frequency regularized data 202, process the frequency regularized data 202, and generate the output(s) 112. In examples, the output(s) 112 may include a neural rendering based on the frequency regularized data 202. The training engine 108 may obtain the output(s) 112 and compare them with ground truth data 114 to compute losses to optimize the NeRF 104. The ground truth data 114 may include, among other things, radiance values 116, opacity values 118, and density values 120. These values may be compared with respective counterpart values in the output(s) 112 to evaluate the performance of the NeRF 104. For instance, losses may be calculated based on differences in the ground truth data values and the output values to determine metrics, and the training engine 108 may optimize the NeRF 104 based on these losses and/or metrics.

The training engine 108 may compare the radiance, opacity, and density values of a point in 3D space that is included in the output(s) 112, with respective radiance, opacity, and density values of a point included in the ground truth data 114 to determine losses and optimize the NeRF 104. After the training engine 108 optimizes the NeRF 104 after one training iteration, the process 200 repeats with the frequency regularization component 102 using an increased frequency mask to train the NeRF 104 with a higher level of frequency signals. That is, the frequency regularization component may generate frequency regularized data 202 having a longer visible frequency band. This repetitive training process may continue to repeat until the NeRF 104 is trained with full-frequency signals and/or the output(s) 112 of the NeRF are satisfactory (e.g., losses are minimized).

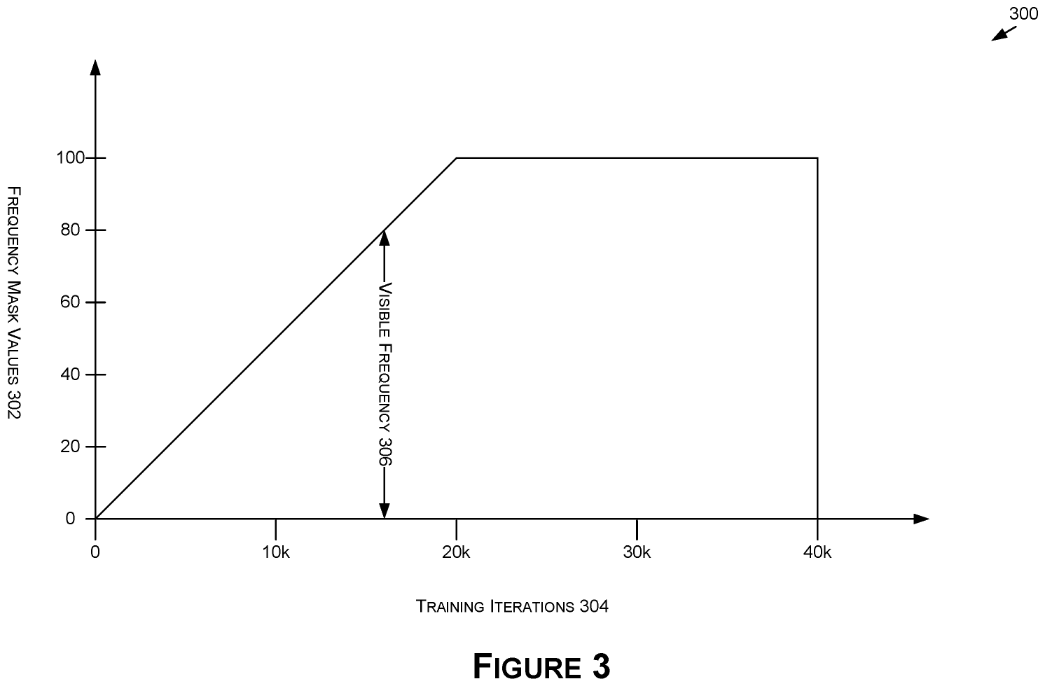

FIG. 3 is a graph 300 illustrating a linear relationship between frequency mask values 302 and training iterations 304 for frequency regularized training of a NeRF, in accordance with some embodiments of the present disclosure. The frequency mask values 302 are plotted on the vertical axis (e.g., traditional y-axis) of the graph 300 and the number of training iterations 304 are plotted on the horizontal axis (e.g., traditional x-axis) of the graph 300. As depicted in the graph 300, as the number of training iterations 304 increases, the frequency mask values 302 and the visible frequency 306 increase as well. That is, frequency mask values 302 and/or visible frequency 306 increases linearly for each successive training iteration of the NeRF. This may continue until reaching a maximum value for the visibility frequency, at which point one or more training iterations may continue using this maximum value of the visibility frequency. While the example of FIG. 3 illustrates example values for the frequency mask values 302 and the training iterations 304, in other examples, the values for the frequency mask values 302 and/or the training iterations 304 may differ from that in the example of FIG. 3.

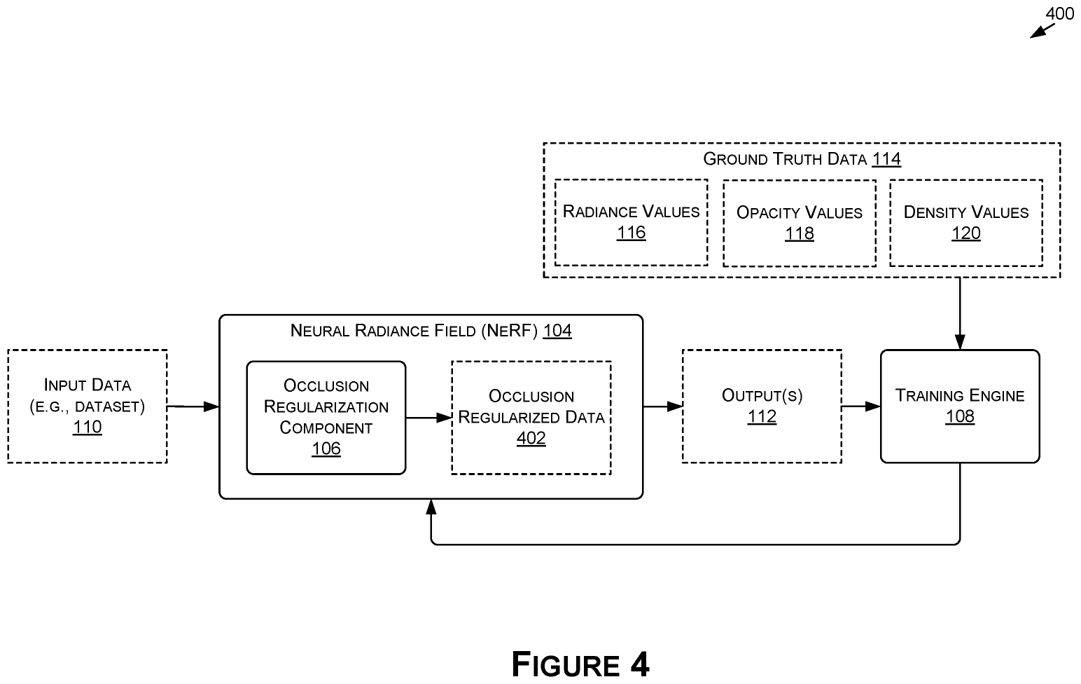

FIG. 4 is a data flow diagram illustrating an example process 400 associated with training a NeRF that utilizes occlusion regularization, in accordance with some embodiments of the present disclosure. As illustrated in FIG. 4, various system(s) and component(s) may be involved in the process 400. For instance, the NeRF 104, the occlusion regularization component 106, and the training engine 108 may perform various operations associated with the process 400.

In some examples, the process 400 may begin by the NeRF 104 receiving or otherwise obtaining the input data 110. In some examples, the input data 110 may be a dataset for training the NeRF 104 to generate a few-shot neural rendering. In some examples, the dataset may be used to train the NeRF to understand 3D structure of scene(s), allowing the NeRF to generate novel views or render scene(s) from different perspectives. In some examples, the dataset may include one or more images or scenes captured from various viewpoints, along with corresponding depth and color information. That is, the dataset may include various images, depth maps, camera poses, and other/or information needed to train and test the NeRF model effectively. In some examples, the input data 110 may include one or more positional encodings for optimizing the NeRF 104.

In examples, the NeRF 104 may perform ray casting to render a 3D scene based on the input data 110. As part of this, the NeRF 104 may determine a first density score associated with a first point of multiple points disposed along a ray cast from an origin through a pixel of an input image. In some examples, the first density score may be one of multiple density scores associated with respective points of the multiple points disposed along the ray. For instance, the first density score may be distinguishable from a second density score associated with a second point of the multiple points disposed along the ray. Additionally, in some examples, the ray may be one of multiple rays cast from the origin, and one or more rays (e.g., each ray) of the multiple rays may pass through a respective pixel of the image.

In examples, the occlusion regularization component 106 may perform occlusion regularization on the density values determined by the NeRF 104 during ray casting. For instance, the occlusion regularization component 106 may penalize dense fields near a ray's origin (e.g., camera) so that the NeRF 104 does not misinterpret those dense fields and include occlusion(s) in the output(s) 112. For instance, the occlusion regularization component 106 may mask one or more density scores/points that are located within a threshold proximity of an origin of a ray to reduce an occlusion in the output(s) 112. That is, the occlusion regularization component 106 may cause one or more density scores to be excluded when the NeRF 104 determines the neural rendering output(s) 112. This has the effect of reducing occlusions in the output(s) 112. In some examples, the occlusion regularization component 106 may cause density score(s) to be excluded based at least on a distance between the origin and point(s) corresponding with the density score(s). For instance, if the distance between the origin and a point is less than a threshold (e.g., 1 cm, 2 cm, etc.), then the occlusion regularization component 106 may cause that point and/or its density score to be excluded via the binary mask.

In some examples, the occlusion regularization component 106 may reduce density scores linearly (and/or using another techniques) along a ray the further it gets from the origin until reaching no reduction. For example, if a ray includes 10 points, the occlusion regularization component may reduce the density score of the first point (e.g., closest to origin) by a first amount, reduce the density score of the second point (e.g., next closest to the origin) by a second amount that is less than the first amount, and continue this process for a set number of points and/or until the amount the density score is reduced by is zero. For instance, in continuing the above example, at the fifth point from the origin the occlusion regularization component may stop decreasing density scores.

In some examples, the occlusion regularization component 106 may output occlusion regularized data 402. In some instances, the occlusion regularization component 106 may determine the occlusion regularized data 406 at some point after NeRF ray generation and some point before at least one of volume rendering or neural network evaluation. The occlusion regularized data 402 may exclude density scores associated with ray data (e.g., 3D points) that are located within a threshold distance of the origin/camera and/or reduced density scores associated with additional ray data (e.g., 3D points) that are located along the ray. In other words, instead of allowing the density scores for each point along a ray to be evaluated by the neural network, the occlusion regularization component 106, by way of the occlusion regularized data 402, may exclude those density scores for those points along the ray that are close to (e.g., within a threshold distance of) the origin/camera.

After performing various operations to process and evaluate the occlusion regularized data 402, the NeRF 104 may generate the output(s) 112. In examples, the output(s) 112 may include a neural rendering based on the input data 110 and/or the occlusion regularized data 402. The training engine 108 may compare the output(s) 112 with ground truth data 114 to compute losses and optimize the NeRF 104. The ground truth data 114 may include, among other things, radiance values 116, opacity values 118, and density values 120. These values may be compared with respective counterpart values in the output(s) 112 to evaluate the performance of the NeRF 104. For instance, losses may be calculated based on differences in the ground truth data values and the output values to determine metrics, and the training engine 108 may optimize the NeRF 104 based on these losses and/or metrics.

The training engine 108 may compare the radiance, opacity, and density values of a point in 3D space that is included in the output(s) 112, with respective radiance, opacity, and density values of a point included in the ground truth data 114 to determine losses and optimize the NeRF 104. After the training engine 108 optimizes the NeRF 104 (e.g., alters parameters to decrease losses), the process 400 may repeat to re-evaluate and, if needed, re-optimize the NeRF 104.

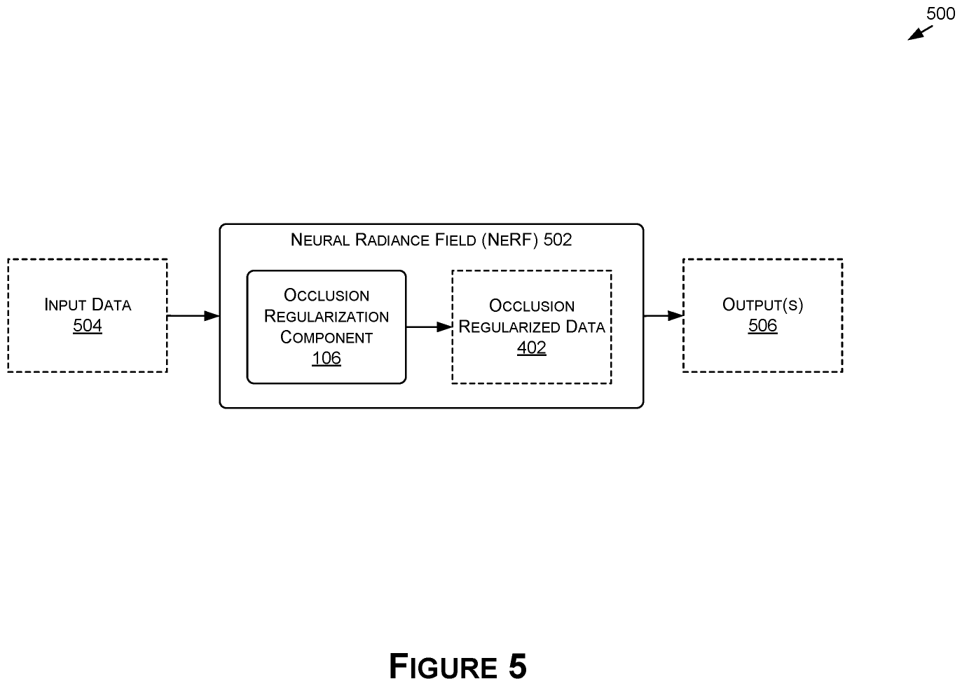

FIG. 5 is a data flow diagram illustrating an example process 500 associated with a NeRF 502 that utilizes occlusion regularization techniques to generate few-shot neural renderings, in accordance with some embodiments of the present disclosure. The NeRF 502 illustrated in FIG. 5 may represent a fully trained/optimized NeRF model/system.

In some examples, the process 500 may begin by the NeRF 502 receiving or otherwise obtaining the input data 504. In some examples, the input data 504 may include one or more images (e.g., 2D images) that are to be represented as a 3D scene. For instance, the input data 504 may include a few-shot dataset, such as one or more 2D images, that is to be transformed into a 3D scene. In some examples, the input data 504 may include one or more images or scenes captured from various viewpoints. That is, the input data 504 may include various images, depth maps, camera poses, and other/or information needed to train and test the NeRF model effectively. In some examples, the input data 504 may include one or more positional encodings generated by an encoder. In some examples, the input data 504 may be similar to the input data 110 described above, however, the input data 504 may, in some examples, include less data and/or not be utilized for training purposes.

In some examples, the NeRF 502 may perform ray casting to render a 3D scene based on the input data 504. As part of this, the NeRF 502 may determine a first density score associated with a first point of multiple points disposed along a ray cast from an origin through a pixel of an input image. In some examples, the first density score may be one of multiple density scores associated with respective points of the multiple points disposed along the ray. For instance, the first density score may be distinguishable from a second density score associated with a second point of the multiple points disposed along the ray. Additionally, in some examples, the ray may be one of multiple rays cast from the origin that pass through a respective pixel of the image.

In examples, the occlusion regularization component 106 may perform occlusion regularization on the density scores determined by the NeRF 502 during ray casting. For instance, the occlusion regularization component 106 may penalize dense fields near a ray's origin (e.g., camera) so that the NeRF 502 does not misinterpret those dense fields and include occlusion(s) in the output(s) 506. For instance, the occlusion regularization component 106 may mask one or more density scores/points that are located within a threshold proximity of an origin of a ray to reduce an occlusion in the output(s) 506. That is, the occlusion regularization component 106 may cause one or more density scores to be excluded when the NeRF 502 determines the neural rendering output(s) 506. This has the effect of reducing occlusions in the output(s) 506. In some examples, the occlusion regularization component 106 may cause density score(s) to be excluded based at least on a distance between the origin and point(s) corresponding with the density score(s). For instance, if the distance between the origin and a point is less than a threshold (e.g., 1 cm, 2 cm, etc.), then the occlusion regularization component 106 may cause that point and/or its density score to be excluded via the binary mask.

In examples, the occlusion regularization component 106 may output occlusion regularized data 402. In some instances, the occlusion regularization component 106 may determine the occlusion regularized data 406 at some point after NeRF ray generation and some point before at least one of volume rendering or neural network evaluation. The occlusion regularized data 402 may exclude density scores associated with ray data (e.g., 3D points) that are located within a threshold distance of the origin/camera. In other words, instead of allowing the density scores for each point along a ray to be evaluated by the neural network, the occlusion regularization component 106, by way of the occlusion regularized data 402, may exclude those density scores for those points along the ray that are close to (e.g., within a threshold distance of) the origin/camera.

After performing various operations to process and evaluate the occlusion regularized data 402, the NeRF 502 may generate an output(s) 506. In examples, the output(s) 506 may include a neural rendering based on the input data 504 and/or the occlusion regularized data 402. The neural rendering may be a novel view 3D scene associated with one or more input images included in the input data 504.

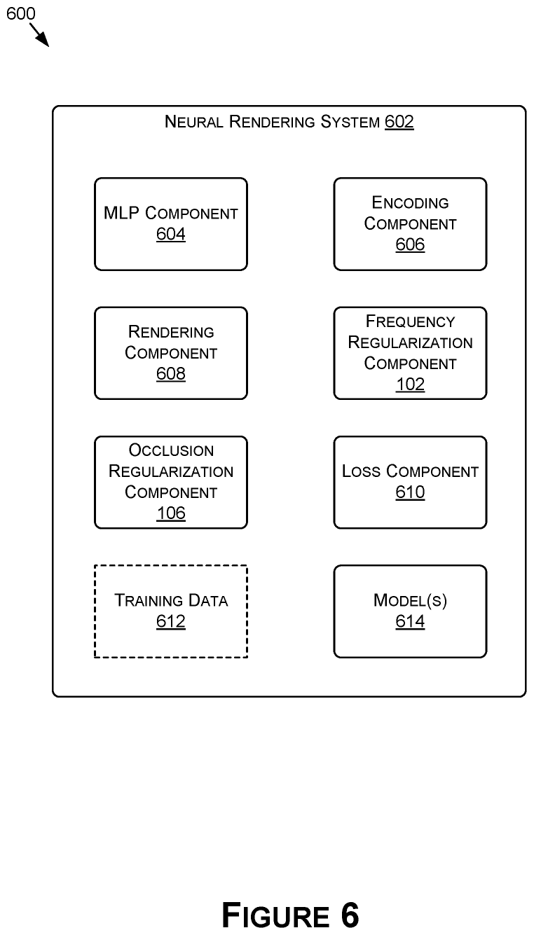

FIG. 6 is a block diagram illustrating example detail 600 of a neural rendering system 602 (e.g., a NeRF) suitable for use in implementing some embodiments of the present disclosure. For instance, the neural rendering system 602 may generate neural renderings based on few-shot inputs using, at least in part, the frequency regularization and occlusion regularization techniques disclosed herein. The neural rendering system 602 may include, among other things, a Multi-layer Perceptron (MLP) component 604, an encoding component 606, a rendering component 608, the frequency regularization component 102, the occlusion regularization component 106, a loss component 610, training data 612, and model(s) 614.

In various examples, the neural rendering system may use the MLP component 604 to represent a scene as a volumetric density field σ and associated RGB (Red, Green, Blue) values c at each point in the scene. In examples, the MLP component 604 may input a 3D coordinate (e.g., x∈ [symbol] ³) and a viewing directional unit vector (e.g., d∈ [symbol] ²) and, based on the input, output the corresponding density and color. In some examples, the neural rendering system 602 may learn a continuous function based on parameters determined by the MLP component 604 (e.g., f_{θ}(x, d)=(σ, c), where θ denotes MLP parameters).

Directly optimizing the neural rendering system 602 over raw inputs (e.g., (x, d)) can lead to difficulty in synthesizing high frequency details. As such, the encoding component 606 may be configured to determine positional encodings by mapping the inputs into a higher dimensional space using, for instance, sinusoidal functions with different frequencies:

$${γ}_{L} ( x ) = [ sin ( x ) , cos ( x ) , … , sin ( {2}^{L - 1} x ) , cos ( {2}^{L - 1} x ) ] ,$$

where L is a hyper-parameter controlling the maximal encoded frequency and usually differs for coordinates x and directional vectors d. Additionally, in some examples, the encoding component 606 may concatenate the raw inputs with the frequency-encoded inputs, as:

$${x}^{′} = [ x , {γ}_{L} ( x ) ]$$

This concatenation may be applied to both coordinate inputs and view direction inputs.

The rendering component 608 may be configured to render pixels for the neural rendering system 602 by casting a ray (e.g., r(t)=o+td) from the camera's origin o along the direction d to pass through the pixel, where t is the distance to the origin. Within the near and far bounds [tₙₑₐᵣ, t_{far}] of the cast ray, the neural rendering system 602 may compute the color of that ray using the quadrature of K sampled points T_{K}={T₁, . . . , T_{K}}:

$$\hat{c} ( r ; θ , {t}_{K} ) = {Σ}_{K} {T}_{k} ( 1 - exp ( - {σ}_{k} ( {t}_{k + 1} - {t}_{k} ) ) ) {c}_{k} ,$$

$$with$$

$${T}_{k} = exp ( - {Σ}_{k ′ < k} {{σ}^{′}}_{k} ( {t}_{k ′ + 1} - {t}_{k ′} ) ) ,$$

where ĉ(r; θ,t_{K}) is the final integrated color. In the above equations, the sampled points t_{K} are in a near-to-far order. That is, a point with smaller index k is closer to the camera's origin.

The frequency regularization component 102, as described above and herein, may modify a positional encoding used to train the neural rendering system 602 by applying a linearly increasing frequency mask. In this way, the neural rendering system 602 (and/or the model(s) 614) are trained using low frequency signals at the beginning of training, and then gradually presented with higher frequency signals as training progresses. In examples, In examples, the frequency regularization component 102 may implement frequency regularization using as little as one line of code, such as, for instance:

$${pos}_{enc [ i n t ( \frac{t * L}{T} ) + 3 : ]} = 0$$

where t denotes the current training iteration, T denotes the regularization duration, and L is the dimension of the input positional encoding. For example, given a positional encoding of length L+3, the frequency regularization component 102 may use a linearly increased frequency mask α to regularize the visible frequency spectrum based on training time steps, formally as:

$${{γ}^{′}}_{L} ( t , T ; x ) = γ L ( x ) ⊙ α ( t , T , L ) ,$$

$$with$$

$${α}_{i} ( t , T , L ) = \{ \begin{matrix}1 & if & i \leq \frac{t * L}{T} + 3 \\ \frac{t * L}{T} - ⌊ \frac{t * L}{T} ⌋ & if & \frac{t * L}{T} + 3 < i \leq \frac{t * L}{T} + 6 \\ 0 & if & i > \frac{t * L}{T} + 6\end{matrix}$$

where αᵢ(t, T, L) denotes the value of i-th bit of α(t, T, L), t represents the current training iteration, and T represents the end iteration of frequency regularization. In plain terms, to train/optimize the model(s) 614, the neural rendering system 602, via the frequency regularization component 102, may start with raw inputs and linearly increase the visible frequency (e.g., by 3-bits in the above example equations) each time as training progresses.

The occlusion regularization component 106, as described above and herein, may penalize near-camera dense fields to avoid occlusions (e.g., floaters, walls, etc.) in a few-shot neural rendering, which are commonly induced by the least overlapped regions in training views. That is, non-overlapping regions or regions with little overlap are hard to estimate in terms of geometry because of extremely limited information (e.g., one-shot) and, therefore, the model(s) 614 may interpret these unexplored areas as dense volumetric floaters near the camera. Accordingly, the occlusion regularization component 106 may implement occlusion regularization by penalizing dense fields near a ray's origin (e.g., camera). In examples, occlusion regularization losses may be defined as:

$${ℒ}_{occ} = \frac{{σ}_{K}^{T} \cdot {m}_{K}}{K} = \frac{1}{K} {Σ}_{K} {σ}_{K} \cdot {m}_{K} ,$$

$$with$$

$${m}_{K} ∈ \{ 0 , 1 \} ,$$

where m_{K} is a mask (e.g., binary mask) to indicate penalized bits, and ok denotes the density scores of the sampled K points along the ray from near to far with respect to the origin. In some examples, the lower M bits of m_{K} may be set to “1” and the upper M bits of m_{K} may be set to “0” to reduce the near-origin dense fields and minimize occlusions.

The loss component 610 may compute losses between outputs of the model(s) 614 and/or the neural rendering system 602 and ground truth data included in the training data 612. For instance, the training data may include the ground truth data 114 described above, and the loss component 610 may compute a loss between radiance values determined by the model(s) 614 and the radiance values 116 of the ground truth data 114. In examples, the model(s) 614 may include one or more NeRF models and/or other machine-learning models.

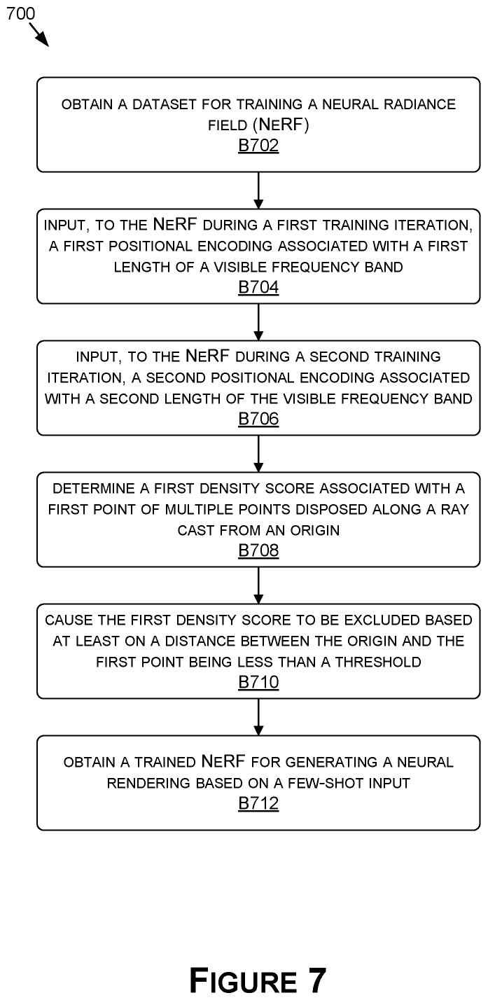

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), or a plug-in to another product, to name a few. In addition, the methods are described, by way of example, with respect to the system of FIG. 1. However, these methods may additionally or alternatively be executed by any one system, or any combination of systems, including, but not limited to, those described herein.

FIG. 7 is a flowchart illustrating an example method 700 associated with training a NeRF to generate a few-shot neural rendering, in accordance with some embodiments of the present disclosure. At block B702, the method 700 includes obtaining a dataset for training a NeRF. For instance, the frequency regularization component 102 may obtain the dataset (e.g., input data 110) for training the NeRF 104. In some examples, the dataset may include one or more images or scenes captured from various viewpoints, along with corresponding depth and color information. That is, the dataset may include various images, depth maps, camera poses, and other/or information needed to train and test the NeRF 104 model effectively. In some examples, the dataset may include one or more positional encodings.

In some examples, the frequency regularization component 102 may determine masked (e.g., integrated) version(s) of the positional encoding(s) from the training dataset. These masked positional encoding(s) may be used to train the NeRF 104 in a way that the NeRF 104 is exposed to only low frequency signals at the beginning of training, and later introduced to higher frequency signals as training progresses. In examples, the frequency regularization component 102 may linearly increase the visible frequency (e.g., by 3-bits in the above example equations) of the positional encoding each time as training progresses.

At block B704, the method 700 includes inputting, to the NeRF during a first training iteration, a first positional encoding associated with a first length of a visible frequency band. For instance, the frequency regularization component 102 may input, to the NeRF 104 during the first training iteration, the positional encoding associated with the first length of the visible frequency band. In examples, the first positional encoding may be associated with the first length of the visible frequency band based at least on the frequency regularization component 102 applying a first frequency mask to the first positional encoding. In other words, based at least on the frequency regularization component 102 applying the first frequency mask, a first range of signals (e.g., low frequency signals) in the positional encoding/training data may be visible to the NeRF 104 for the first training iteration.

In some examples, the NeRF 104 may be trained in the first iteration using the first positional encoding. That is, the NeRF 104 may generate the output(s) 112, and the training engine 108 may optimize the NeRF 104 based on losses. This may happen during the first training iteration, and subsequent training iterations may be performed if necessary.

At block B706, the method 700 includes inputting, to the NeRF during a second training iteration, a second positional encoding associated with a second length of the visible frequency band. For instance, the frequency regularization component 102 may input, to the NeRF 104 during the second training iteration, the second positional encoding associated with the second length of the visible frequency band. In examples, the second positional encoding may be associated with the second length of the visible frequency band based at least on frequency regularization component 102 applying a second frequency mask to the second positional encoding. That is, based at least on the frequency regularization component 102 applying the second frequency mask, a second range of signals (e.g., low frequency signals and at least a portion of higher frequency signals) in the positional encoding/training data may be visible to the NeRF 104 in the second training iteration.

In some examples, the first length of the visible frequency band may be shorter or otherwise associated with a lower frequency than the second length of the visible frequency band. That is, the first length may be shorter than the second length such that, in the second training iteration, the second positional encoding includes all the frequency signals from the first positional encoding in addition to new frequency signals that are higher in frequency than those from the first position encoding. As an example, based at least on a difference between the first length of the visible frequency band and the second length of the visible frequency band, the first positional encoding may include a first signal of the dataset while excluding a second signal of the dataset. Additionally, the second positional encoding may include the first signal and the second signal while excluding a third signal of the data set. For instance, the third signal may have a frequency value that is outside of the first length and/or the second length of the visible frequency band.

Additionally, or alternatively, the first length of the visible frequency band may be associated with a different section of the visible frequency band than the second length. That is, the first length may be associated with a first section or wavelength of the visible frequency band (e.g., 400-420 nm) while the second length may be associated with a second section or wavelength of the visible frequency band (e.g., 420-490 nm). In such examples, the second positional encoding used during the second training iteration may include different frequency signals associated with a higher frequency than the frequency signals included in the first positional encoding used during the first training iteration.

At block B708, the method 700 includes determining a first density score associated with a first point of multiple points disposed along a ray cast from an origin. For instance, the NeRF 104 may determine the first density score associated with the first point of the multiple points disposed along the ray cast from the origin. In some examples, determining the first density score may include determining a location or position of the density score and/or the first point with respect to the ray's origin. That is, determining the first density score may include determining how close the first point is to the origin (e.g., 1 cm, 2 cm, etc.)

At block B710, the method 700 includes causing the first density score to be excluded based at least on a distance between the origin and the first point being less than a threshold. For instance, the occlusion regularization component 106 may cause the first density score to be excluded based at least on the distance between the origin and the first point being less than a threshold (e.g., 3 cm, 4 cm, etc.). In some examples, the occlusion regularization component 106 may implement a mask (e.g., binary mask) to penalize bits that are located nearby the camera origin to reduce near-camera dense fields and minimize occlusions in the output.

In some examples, the occlusion regularization component 106 may apply the binary mask across the entire data structure exclude all points/density scores that are within the threshold distance of the origin/camera. Additionally, or alternatively, the occlusion regularization component 106 may identify a location(s) associated with the dense regions (e.g., from preliminary outputs, from non-overlapping regions in the input data/images, etc.) and apply the binary mask to at that/those location(s).

In examples, the binary mask may be applied to mask density scores/points to a certain depth/distance away from the origin. In effect, the binary mask may allow the occlusion regularization component 106 to cause a second density score to be included (e.g., considered by the NeRF 104 in generating the neural rendering) based at least on a distance between the origin and the second point meeting or exceeding the threshold. That is, if the occlusion regularization component 106 utilize the binary mask to exclude all points/density scores within a threshold distance (e.g., 1 cm, 2 cm, etc.) of the origin, then the points/density scores beyond that threshold distance may be left unmasked so that they are considered by the NeRF 104 in rendering the novel view.

At block B712, the method 700 includes obtaining a trained NeRF for generating a neural rendering based on a few-shot input. For instance, the training engine 108 may obtain the trained NeRF by optimizing the NeRF 104 during successive training iterations.

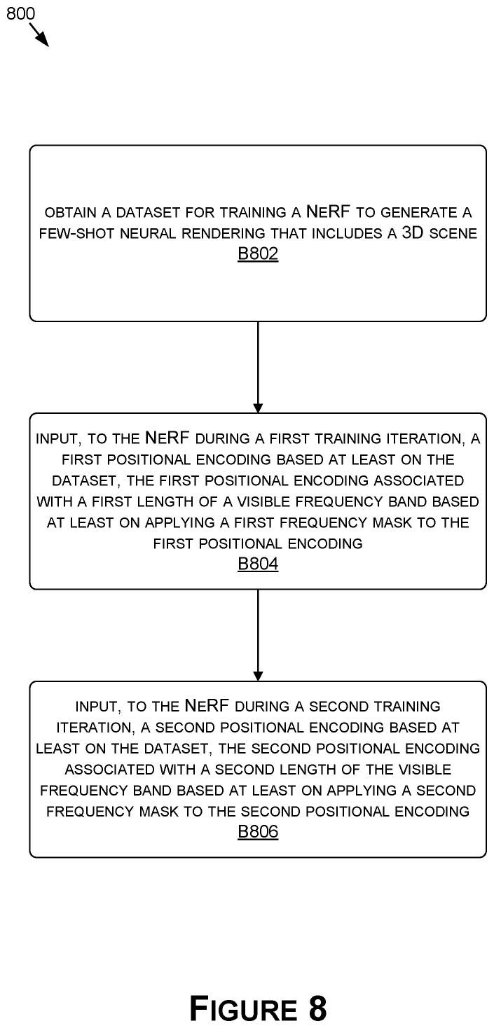

FIG. 8 is a flowchart illustrating an example method 800 associated with using frequency regularization when training a NeRF to generate a few-shot neural rendering, in accordance with some embodiments of the present disclosure. At block B802, the method 800 includes obtaining a dataset for training a NeRF to generate a few-shot neural rendering that includes a 3D scene. For instance, the frequency regularization component 102 may obtain the dataset (e.g., input data 110) for training the NeRF 104 to generate the few-shot neural rendering that includes the 3D scene. In some examples, the dataset may include one or more images or scenes captured from various viewpoints, along with corresponding depth and color information. That is, the dataset may include various images, depth maps, camera poses, and other/or information needed to train and test the NeRF 104 model effectively. In some examples, the dataset may include one or more positional encodings.

In some examples, the frequency regularization component 102 may determine masked (e.g., integrated) version(s) of the positional encoding(s) from the training dataset. These masked positional encoding(s) may be used to train the NeRF 104 in a way that the NeRF 104 is exposed to only low frequency signals at the beginning of training, and later introduced to higher frequency signals as training progresses. In examples, the frequency regularization component 102 may linearly increase the visible frequency (e.g., by 3-bits in the above example equations) of the positional encoding each time as training progresses.

At block B804, the method 800 includes inputting, to the NeRF during a first training iteration, a first positional encoding based at least on the dataset, the first positional encoding associated with a first length of a visible frequency band based at least on applying a first frequency mask to the first positional encoding. For instance, the frequency regularization component 102 may input, to the NeRF 104 during the first training iteration, the first positional encoding. In examples, the first positional encoding may be associated with the first length of the visible frequency band based at least on the frequency regularization component 102 applying the first frequency mask to the first positional encoding. In other words, based at least on the frequency regularization component 102 applying the first frequency mask, a first range of signals (e.g., low frequency signals) in the positional encoding/training data may be visible to the NeRF 104 for the first training iteration.

In some examples, the NeRF 104 may be trained in the first iteration using the first positional encoding. That is, the NeRF 104 may generate the output(s) 112, and the training engine 108 may optimize the NeRF 104 based on losses. This may happen during the first training iteration, and subsequent training iterations may be performed if necessary.

At block B806, the method 800 includes inputting, to the NeRF during a second training iteration, a second positional encoding based at least on the dataset, the second positional encoding associated with a second length of the visible frequency band based at least on applying a second frequency mask to the second positional encoding. For instance, the frequency regularization component 102 may input, to the NeRF 104 during the second training iteration, the second positional encoding. In examples, the second positional encoding may be associated with the second length of the visible frequency band based at least on the frequency regularization component 102 applying the second frequency mask to the second positional encoding. That is, based at least on the frequency regularization component 102 applying the second frequency mask, a second range of signals (e.g., low frequency signals and at least a portion of higher frequency signals) in the positional encoding/training data may be visible to the NeRF 104 in the second training iteration.

In some examples, the first length of the visible frequency band may be shorter or otherwise associated with a lower frequency than the second length of the visible frequency band. That is, the first length may be shorter than the second length such that, in the second training iteration, the second positional encoding includes all the frequency signals from the first positional encoding in addition to new frequency signals that are higher in frequency than those from the first position encoding. As an example, based at least on a difference between the first length of the visible frequency band and the second length of the visible frequency band, the first positional encoding may include a first signal of the dataset while excluding a second signal of the dataset. Additionally, the second positional encoding may include the first signal and the second signal while excluding a third signal of the data set. For instance, the third signal may have a frequency value that is outside of the first length and/or the second length of the visible frequency band.

Additionally, or alternatively, the first length of the visible frequency band may be associated with a different section of the visible frequency band than the second length. That is, the first length may be associated with a first section or wavelength of the visible frequency band (e.g., 400-420 nm) while the second length may be associated with a second section or wavelength of the visible frequency band (e.g., 420-490 nm). In such examples, the second positional encoding used during the second training iteration may include different frequency signals associated with a higher frequency than the frequency signals included in the first positional encoding used during the first training iteration.

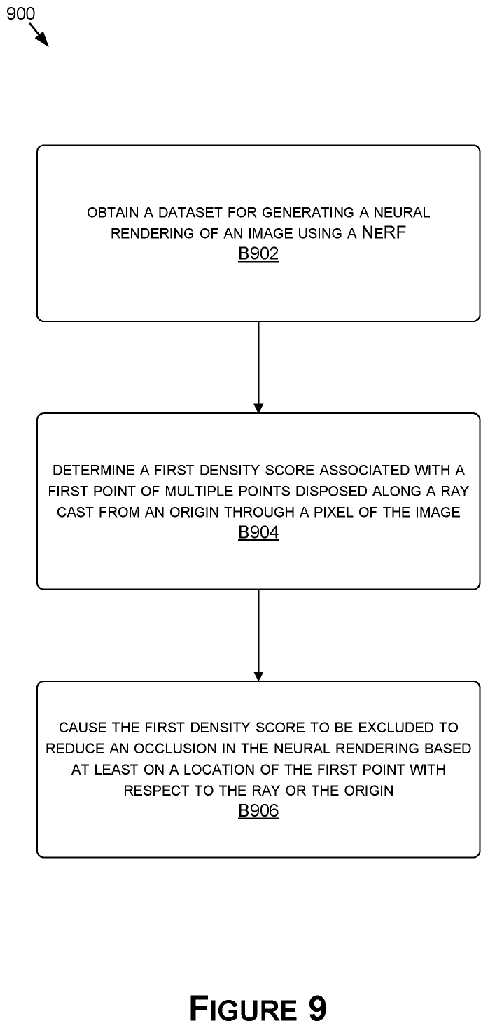

FIG. 9 is a flowchart illustrating an example method 900 associated with using occlusion regularization in association with a NeRF to generate a few-shot neural rendering, in accordance with some embodiments of the present disclosure. At block B902, the method 900 includes obtaining a dataset for generating a neural rendering of an image using a NeRF. For instance, the NeRF 104 may obtain the dataset (e.g., input data 110) for generating the neural rendering of the image. In some examples, the dataset may include, in addition to the image, one or more additional images or scenes associated with the image and captured from various viewpoints. That is, the dataset may include various images, depth maps, camera poses, and other/or information. In some examples, the dataset may include one or more positional encodings.

At block B904, the method 900 includes determining a first density score associated with a first point of multiple points disposed along a ray cast from an origin through a pixel of the image. For instance, the NeRF 104 may determine the first density score associated with the first point of the multiple points disposed along the ray cast from the origin through the pixel. In some examples, determining the first density score may include determining a location or position of the density score and/or the first point with respect to the ray's origin. That is, determining the first density score may include determining how close the first point is to the origin (e.g., 1 cm, 2 cm, etc.)

At block B906, the method 900 includes causing the first density score to be excluded to reduce an occlusion in the neural rendering based at least on a location of the first point with respect to the ray or the origin. For instance, the occlusion regularization component 106 may cause the first density score to be excluded to reduce the occlusion in the neural rendering based at least on the location of the first point with respect to the ray or the origin. For instance, if the location of the first point is less than a threshold (e.g., 3 cm, 4 cm, etc.) distance from the origin, the first point may be excluded. In some examples, the occlusion regularization component 106 may exclude the first point and/or other points by implementing a mask (e.g., binary mask) to penalize bits that are located nearby the camera origin to reduce near-camera dense fields and minimize occlusions in the output.

In some examples, the occlusion regularization component 106 may apply the binary mask uniformly across the entire data structure exclude all points/density scores that are within the threshold distance of the origin/camera. Additionally, or alternatively, the occlusion regularization component 106 may identify a location(s) associated with the dense regions (e.g., from preliminary outputs, from non-overlapping regions in the input data/images, etc.) and apply the binary mask to at that/those location(s).

In examples, the binary mask may be applied to mask density scores/points to a certain depth/distance away from the origin. In effect, the binary mask may allow the occlusion regularization component 106 to cause a second density score to be included (e.g., considered by the NeRF 104 in generating the neural rendering) based at least on a distance between the origin and the second point meeting or exceeding the threshold. That is, if the occlusion regularization component 106 utilize the binary mask to exclude all points/density scores within a threshold distance (e.g., 1 cm, 2 cm, etc.) of the origin, then the points/density scores beyond that threshold distance may be left unmasked so that they are considered by the NeRF 104 in rendering the novel view.

### Example Computing Device

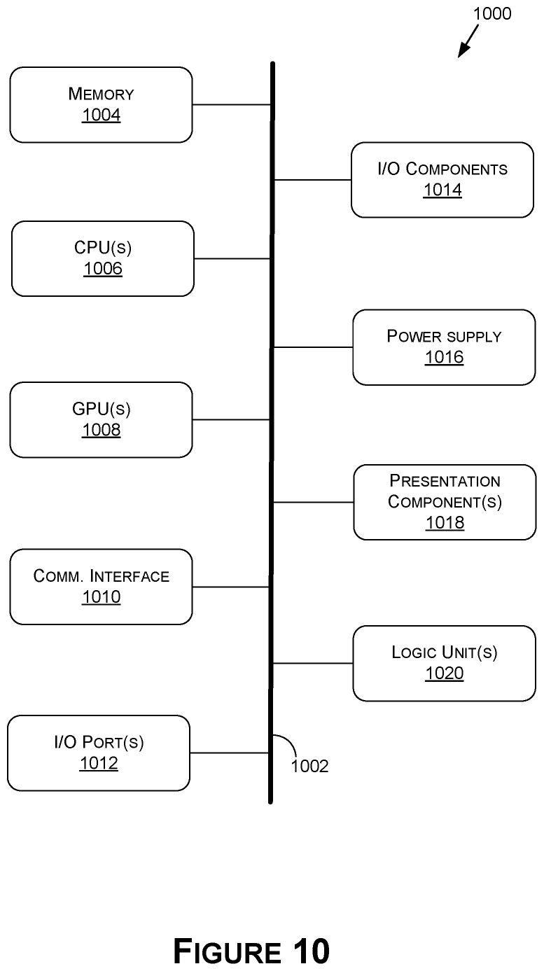

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

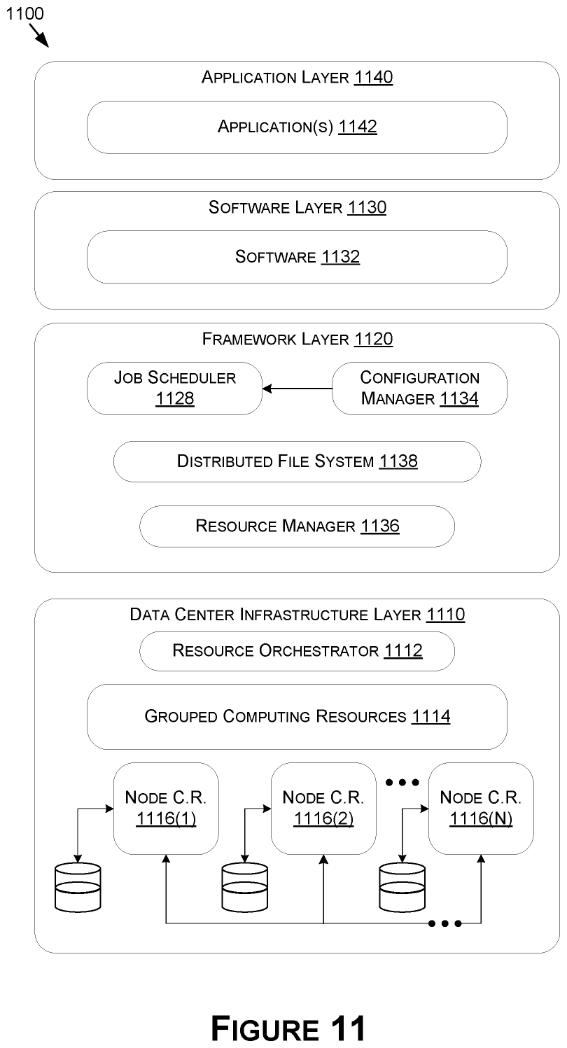

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory, or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: obtaining a dataset for training a neural radiance field (NeRF) to generate a few-shot neural rendering that includes a three dimensional (3D) scene; inputting, to the NeRF during a first training iteration, a first positional encoding of the dataset, the first positional encoding associated with a first length of a visible frequency band based at least on applying a first frequency mask to the first positional encoding; and inputting, to the NeRF during a second training iteration, a second positional encoding of the dataset, the second positional encoding associated with a second length of the visible frequency band based at least on applying a second frequency mask to the second positional encoding.
B: The method of paragraph A, further comprising obtaining, based at least on the first training iteration and the second training iteration, a trained NeRF configured to generate the few-shot neural rendering while minimizing at least one of overfitting or underfitting in the 3D scene.
C: The method of paragraph A or paragraph B, wherein the first length of the visible frequency band is at least one of shorter or associated with a lower frequency than the second length of the visible frequency band, and wherein the first training iteration occurring before the second training iteration.
D: The method of any one of paragraphs A-C, further comprising inputting, to the NeRF during a third training iteration that is subsequent to both the first training iteration and the second training iteration, a third positional encoding of the dataset, the third positional encoding associated with a full length of the visible frequency band.
E: The method of any one of paragraphs A-D, wherein, based at least on a difference between the first length of the visible frequency band and the second length of the visible frequency band, the first positional encoding includes a first signal of the dataset while excluding a second signal of the dataset.
F: The method of any one of paragraphs A-E, wherein the second positional encoding includes the first signal and the second signal while excluding a third signal of the data set, the third signal having a frequency value that is outside of the second length of the visible frequency band.
G: The method of any one of paragraphs A-F, wherein: the first positional encoding includes a first signal of the dataset while excluding a second signal of the dataset, the first signal associated with a first frequency that is less than a threshold; and the second positional encoding includes the first signal and the second signal, the second signal associated with a second frequency that is greater than the threshold.
H: The method of any one of paragraphs A-G, wherein a first value associated with the first frequency mask includes a linear relationship with a second value associated with the second frequency mask, the linear relationship being based at least on the first training iteration of the NeRF and the second training iteration of the NeRF.
I: The method of any one of paragraphs A-H, further comprising, during at least one of the first training iteration or the second training iteration, causing a masking of one or more density scores located within a threshold proximity of an origin of a ray to reduce an occlusion in the 3D scene.
J: A system comprising: one or more processors configured to: obtain a dataset for generating a neural rendering of an image using a Neural Radiance Field (NeRF); determine, using the NeRF, a first density score associated with a first point of multiple points disposed along a ray cast from an origin through a pixel of the image; and based at least on a distance between the origin and the first point being less than a threshold, cause the first density score to be minimized to reduce an occlusion in the neural rendering.
K: The system of paragraph J, wherein the first density score is indicative of a presence of a false dense region detected by the NeRF, the false dense region contributing to the occlusion of a three-dimensional (3D) scene in the neural rendering.
L: The system of paragraph J or paragraph K, wherein the one or more processors are further configured to: input, to the NeRF during a first training iteration, a first positional encoding associated with a first length of a visible frequency band; and input, to the NeRF during a second training iteration, a second positional encoding associated with a second length of the visible frequency band.
M: The system of any one of paragraphs J-L, wherein the first positional encoding is determined based at least on a first frequency mask and the second positional encoding is determined based at least on a second frequency mask that is increased linearly with respect to the first frequency mask.
N: The system of any one of paragraphs J-M, wherein the first density score is distinguishable from a second density score associated with a second point of the multiple points disposed along the ray, the one or more processors further configured to cause the second density score to be included based at least on a second distance between the origin and the second point meeting or exceeding the threshold.
O: The system of any one of paragraphs J-N, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
P: A processor comprising: one or more circuits to train a neural radiance field (NeRF) to generate a neural rendering based on a few shot input dataset by increasing, during successive training iterations, a visible frequency of a positional encoding, and cause a masking of a density score associated with a point disposed along a ray based at least on a distance between the point and an origin of the ray being less than a threshold.
Q: The processor of paragraph P, wherein increasing the visible frequency of the positional encoding comprises increasing a length of a visible frequency band based at least on applying a frequency mask to the positional encoding.
R: The processor of paragraph P or paragraph Q, wherein neural rending comprises a three-dimensional (3D) scene, the NeRF trained to generate the 3D scene while minimizing at least one of overfitting or underfitting in the 3D scene.
S: The processor of any one of paragraphs P-R, wherein the density score is distinguishable from another density score associated with another point disposed along the ray, the one or more circuits to refrain from masking the other density score based at least on the other point being located further from the origin than the point.
T: The processor of any one of paragraphs P-S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining a dataset for training a neural radiance field (NeRF) to generate a few-shot neural rendering that includes a three-dimensional (3D) scene;
inputting, to the NeRF during a first training iteration, a first positional encoding of the dataset, the first positional encoding associated with a first length of a visible frequency band based at least on applying a first frequency mask to the first positional encoding; and
inputting, to the NeRF during a second training iteration, a second positional encoding of the dataset, the second positional encoding associated with a second length of the visible frequency band based at least on applying a second frequency mask to the second positional encoding.

2. The method of claim 1, further comprising obtaining, based at least on the first training iteration and the second training iteration, a trained NeRF configured to generate the few-shot neural rendering while minimizing at least one of overfitting or underfitting in the 3D scene.

3. The method of claim 1, wherein the first length of the visible frequency band is at least one of shorter or associated with a lower frequency than the second length of the visible frequency band, and wherein the first training iteration occurring before the second training iteration.

4. The method of claim 1, further comprising inputting, to the NeRF during a third training iteration that is subsequent to both the first training iteration and the second training iteration, a third positional encoding of the dataset, the third positional encoding associated with a full length of the visible frequency band.

5. The method of claim 1, wherein, based at least on a difference between the first length of the visible frequency band and the second length of the visible frequency band, the first positional encoding includes a first signal of the dataset while excluding a second signal of the dataset.

6. The method of claim 5, wherein the second positional encoding includes the first signal and the second signal while excluding a third signal of the data set, the third signal having a frequency value that is outside of the second length of the visible frequency band.

7. The method of claim 1, wherein:
the first positional encoding includes a first signal of the dataset while excluding a second signal of the dataset, the first signal associated with a first frequency that is less than a threshold; and
the second positional encoding includes the first signal and the second signal, the second signal associated with a second frequency that is greater than the threshold.

8. The method of claim 1, wherein a first value associated with the first frequency mask includes a linear relationship with a second value associated with the second frequency mask, the linear relationship being based at least on the first training iteration of the NeRF and the second training iteration of the NeRF.

9. The method of claim 1, further comprising, during at least one of the first training iteration or the second training iteration, causing a masking of one or more density scores located within a threshold proximity of an origin of a ray to reduce an occlusion in the 3D scene.

10. A system comprising:
one or more processors configured to:
obtain a dataset for generating a neural rendering of an image using a Neural Radiance Field (NeRF);
determine, using the NeRF, a first density score associated with a first point of multiple points disposed along a ray cast from an origin through a pixel of the image; and
based at least on a distance between the origin and the first point being less than a threshold, cause the first density score to be minimized to reduce an occlusion in the neural rendering.

11. The system of claim 10, wherein the first density score is indicative of a presence of a false dense region detected by the NeRF, the false dense region contributing to the occlusion of a three-dimensional (3D) scene in the neural rendering.

12. The system of claim 10, the one or more processors further configured to:
input, to the NeRF during a first training iteration, a first positional encoding associated with a first length of a visible frequency band; and
input, to the NeRF during a second training iteration, a second positional encoding associated with a second length of the visible frequency band.

13. The system of claim 12, wherein the first positional encoding is determined based at least on a first frequency mask and the second positional encoding is determined based at least on a second frequency mask that is increased linearly with respect to the first frequency mask.

14. The system of claim 10, wherein the first density score is distinguishable from a second density score associated with a second point of the multiple points disposed along the ray, the one or more processors further configured to cause the second density score to be included based at least on a second distance between the origin and the second point meeting or exceeding the threshold.

15. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

16. A processor comprising:
one or more circuits to train a neural radiance field (NeRF) to generate a neural rendering based on a few-shot input dataset by increasing, during successive training iterations, a visible frequency of a positional encoding, and cause a masking of a density score associated with a point disposed along a ray based at least on a distance between the point and an origin of the ray being less than a threshold.

17. The processor of claim 16, wherein increasing the visible frequency of the positional encoding comprises increasing a length of a visible frequency band based at least on applying a frequency mask to the positional encoding.

18. The processor of claim 16, wherein neural rending comprises a three-dimensional (3D) scene, the NeRF trained to generate the 3D scene while minimizing at least one of overfitting or underfitting in the 3D scene.

19. The processor of claim 16, wherein the density score is distinguishable from another density score associated with another point disposed along the ray, the one or more circuits to refrain from masking the other density score based at least on the other point being located further from the origin than the point.

20. The processor of claim 16, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center, or
a system implemented at least partially using cloud computing resources.
